(19) United States
(12) Patent Application Publication
(10) Pub. No.: US 2026/0180850 A1
(43) Pub. Date: Jun. 25, 2026

(54) DETECTION AND MITIGATION OF NETWORK ISSUES FOR A HYPERVISOR CONFIGURATION

(71) Applicant: INTERNATIONAL BUSINESS MACHINES CORPORATION, ARMONK, NY (US)

(72) Inventors: Robert Lynch, Bedminster, NJ (US); Kevin James Kleinschmidt, Poughkeepsie, NY (US); Justin Davis, Pawling, NY (US); Robert J. Brenneman, Stormville, NY (US)

(21) Appl. No.: 18/987,468

(22) Filed: Dec. 19, 2024

(51) Int. Cl. H04L 41/0681; G06F 9/455; H04L 12/46; H04L 41/0668; H04L 41/40; H04L 43/0811; H04L 43/20

(52) U.S. Cl. CPC H04L 41/0681; G06F 9/45558; H04L 12/4633; H04L 41/0668; H04L 41/40; H04L 43/0811; H04L 43/20; G06F 2009/45595

(57) ABSTRACT

Provided are a method, system, and computer program product for managing network issues in a hypervisor configuration, in which a hypervisor passively monitors a plurality of data points to detect an anomaly and trigger a recovery. The hypervisor determines which media access control (MAC) addresses are gateway addresses, and passively monitors inbound and outbound packets to validate that packets from a gateway are being passed. Responsive to determining, by the hypervisor, that an outbound packet does not have a corresponding inbound packet, the hypervisor triggers a network failure event.

### BACKGROUND

Embodiments relate to a method, system, and computer program product for the detection and mitigation of network issues for a hypervisor configuration.

A hypervisor is a software, firmware, or hardware that allows multiple virtual machines to run on a single physical machine. Every virtual machine has its own operating system and applications. The hypervisor may allocate the underlying physical computing resources such as central processing unit (CPU) and memory to individual virtual machines as required.

Hypervisors are the underlying technology behind virtualization or the decoupling of hardware from software. System administrators may create multiple virtual machines on a single host machine. A user may install software applications on a virtual machine, just like on a physical computer.

### SUMMARY

Provided are a method, system, and computer program product for managing network issues in a hypervisor configuration, in which a hypervisor passively monitors a plurality of data points to detect an anomaly and trigger a recovery. The hypervisor determines which media access control (MAC) addresses are gateway addresses, and passively monitors inbound and outbound packets to validate that packets from a gateway are being passed. Responsive to determining, by the hypervisor, that an outbound packet does not have a corresponding inbound packet, the hypervisor triggers a network failure event.

In additional embodiments, a layer two tunnel is created over a hypervisor management network and operations performed to leverage other hypervisors in a cluster.

In further embodiments, the hypervisor passively monitors broadcast, unknown unicast, and multicast (BUM) packets at a predetermined rate.

In yet further embodiments, in response to the hypervisor determining that the hypervisor has missed a predetermined threshold number of the BUM packets, the hypervisor triggers a link failure mechanism.

In certain embodiments, a plurality of hypervisors synchronize with each other passively captured network traffic that the plurality of hypervisors have received, to determine whether a network path has been interrupted, and to determine which hypervisor to fail to.

In additional embodiments, the hypervisor inspects Transmission Control Protocol (TCP) packets to validate whether there are corresponding acknowledgments being transmitted to determine occurrence of the network failure event.

In further embodiments, each hypervisor of a plurality of hypervisors generates a cost for links to advertise to other hypervisors of the plurality of hypervisors, wherein a selected hypervisor with a failure creates a tunnel to another hypervisor based on the cost.

### BRIEF DESCRIPTION OF THE DRAWINGS

Referring now to the drawings in which like reference numbers represent corresponding parts throughout:

FIG. 1 illustrates a computing environment, in accordance with certain embodiments.

FIG. 2 illustrates a block diagram of a computing environment in which traffic flow is monitored and redirected on detecting a disruption in the traffic flow, in accordance with certain embodiments.

FIG. 3 illustrates a block diagram that shows the detection of broadcast, unknown unicast, and multicast (BUM) traffic, in accordance with certain embodiments.

FIG. 4 illustrates a block diagram that shows a mitigation mechanism, in accordance with certain embodiments.

FIG. 5 illustrates a block diagram that shows a distributed links mitigation mechanism, in accordance with certain embodiments.

FIG. 6 illustrates a flowchart that shows exemplary operations for managing network issues in a hypervisor configuration, in accordance with certain embodiments.

FIG. 7 illustrates a computing environment in which certain components may be implemented, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

In a High Availability (HA) deployment of hypervisors, only a subset of network anomalies may trigger a failover, despite services being impacted. For example, in certain hypervisor environments, active probing (beacon probing) or link status are used to trigger a failover. However, such a mechanism does not look at the whole network, but only look at the local segment.

In certain embodiments, a hypervisor may passively watch multiple data points to detect an anomaly, and then trigger a recovery. Using snooping and a Media Access Control (MAC)/Internet Protocol (IP) Mac/IP bind, the hypervisor determines which MAC addresses are gateway addresses.

Once the gateway is determined, the hypervisor may monitor inbound and outbound packets to validate that packets from the gateway are being passed. If the hypervisor notes that outbound packets do not have corresponding inbound packets, a network failure event may be triggered.

In certain embodiments, depending on the administrator's configuration, network failover may occur by creating a layer 2 tunnel over the hypervisor's management network and by leveraging other hypervisors in the cluster.

Another embodiment may provide mechanisms to monitor Broadcast, Unknown Unicast, Multicast (BUM) traffic on the hypervisor. Hypervisors can sample BUM traffic at specific intervals or rates. Hypervisors can synchronize with each other the BUM traffic they received and determine if their network path has been interrupted.

The embodiments apply to both Link Aggregation Control Protocol (LACP) bonds and Linux balanced bonds. Certain embodiments improve the operations of a computational device by allowing detection and mitigation of network related issues that impact the operations of hypervisor configurations and virtual machines in a computational device.

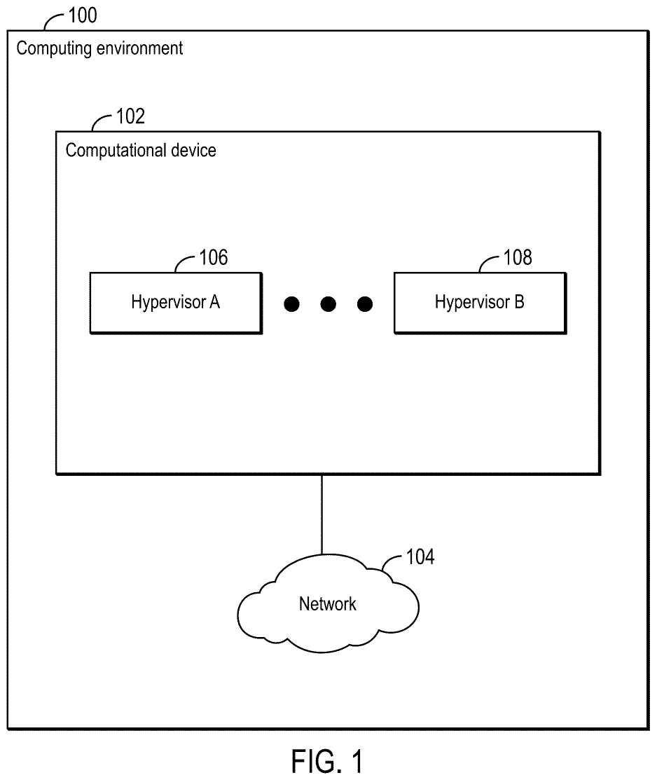

FIG. 1 illustrates a computing environment 100, in accordance with certain embodiments. At least one computational device 102 is coupled to a network 104 in the computing environment 100.

The computational device 102 executes a plurality of hypervisors 106, 108 (shown as hypervisor A 106 and hypervisor B 108). In certain embodiments, the hypervisors 106, 108 may be implemented in hardware, firmware, software, or any combination thereof. While two hypervisors are shown in one computational device 102, in additional embodiments a plurality of hypervisors that may be more than two in number, may execute in a plurality of computational devices in the computing environment 100.

The computational device 102 may in certain embodiments comprise any suitable computational device known in the art such as a server, a personal computer, a laptop, a mainframe, etc. The network 104 may comprise any suitable network known in the art such as the Internet, a local area network, a wide area network, etc. Adapters, routers, switches, etc., may couple the computational device 102 to the network 104.

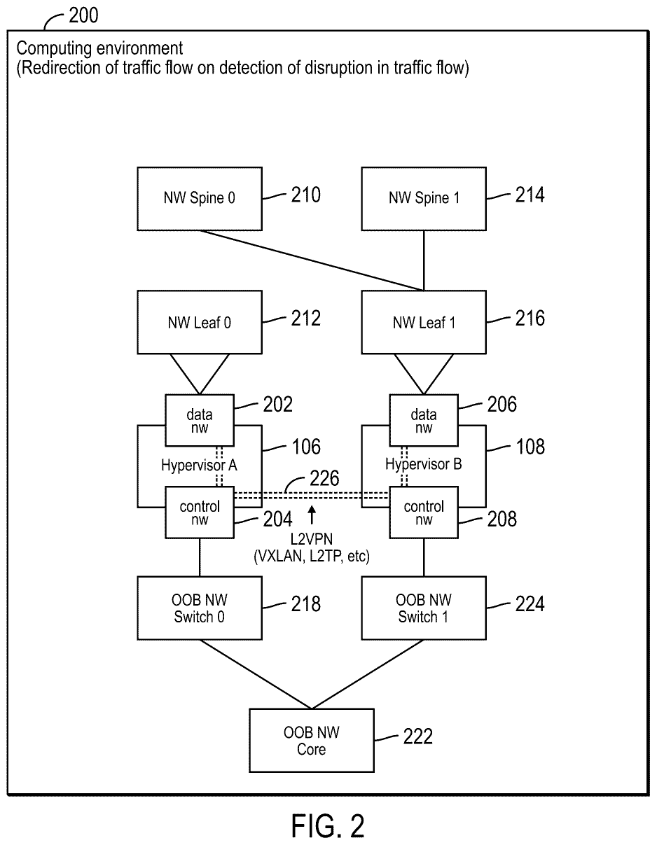

FIG. 2 illustrates a block diagram of a computing environment 200 in which traffic flow is monitored and redirected on detecting a disruption in the traffic flow, in accordance with certain embodiments.

A plurality of hypervisors 106, 108 are deployed in the computing environment 200 with active/active links (a non-LACP is used, where LACP refers to the link aggregation control protocol that is used for communication). In the embodiment, the links are connected to the same leaf. The network topology may either be a spine/leaf topology or a traditional three-tier datacenter.

In FIG. 2, each hypervisor is coupled to a data network (“data nw” and a control network (“control nw”). For example, hypervisor 106 is coupled to a data network 202 and a control network 204, and hypervisor 108 is coupled to a data network 206 and a control network 208. Data networks may be coupled to network leaves that may be coupled to network spines, whereas control network may be coupled to out of band (OOB) network switches 218, 224 and OOB network cores 222. For example, data network 202 may link to network leaf 212 and then to network spine 210 (in FIG. 2 the direct communication between network spine 210 and network leaf 212 is broken), data network 206 may link to network leaf 216 that links to network spine 214. A link is also shown between network leaf 216 and network spine 210.

In FIG. 2, the link between the network spine 210 and network leaf 212 is broken or unable to transfer data correctly. However, data may still be accessed from the network spine 210 by using the control network communication 226 [e.g., via a layer 2 virtual private network (L2VPN) that is comprised of a virtual extensible LAN (VXLAN), level 2 tunneling protocol (L2TP), etc.] to access the data via the hypervisor 108.

The hypervisor 106 (or 108) determines a gateway via dynamic host configuration protocol (DHCP) requests/snooping, user-defined mechanisms, or by monitoring traffic flows. Once the gateway is determined, the hypervisor 106 snoops packets to build a MAC/IP Bind table.

The hypervisor 106 passively monitors packet flows, inspecting Transmission Control Protocol (TCP) packets to validate that there are corresponding acknowledgements being transmitted. If the hypervisor 106 notes a disruption of flow between the gateway and a guest (e.g., guest is sending, but there is no response from gateway), then a network failure event is created.

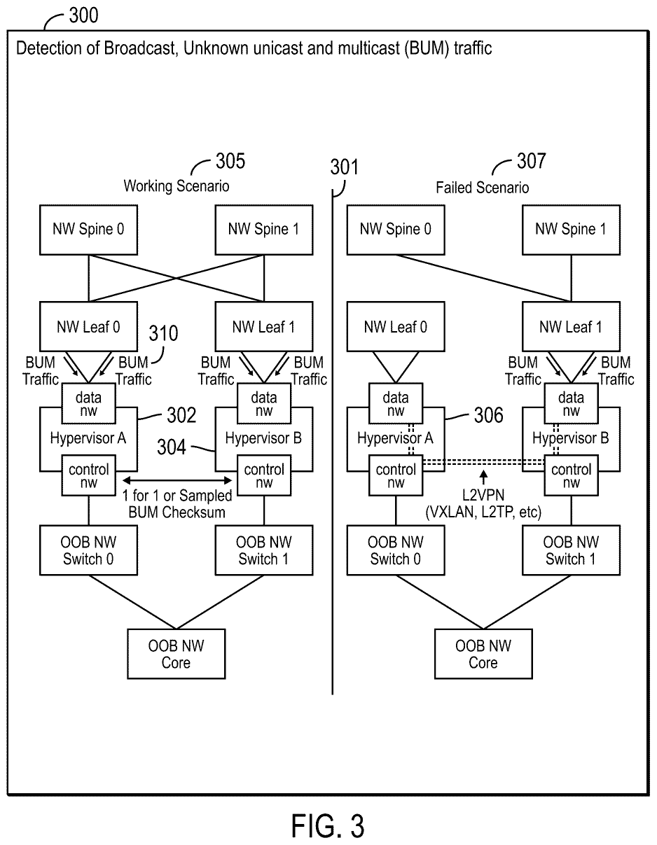

FIG. 3 illustrates block diagram 300 that illustrates the detection of broadcast, unknown unicast, and multicast (BUM) traffic, in accordance with certain embodiments. FIG. 3, continues the topology from the embodiments shown in FIG. 1 and FIG. 2. A vertical line 301 is used to separate a working scenario 305 from a failed scenario 307 to illustrate operations performed in each case.

Broadcast, Unknown Unicast, and Multicast (BUM) traffic (e.g., BUM traffic 310) is broadcasted through all interfaces of a switch. The hypervisors 302, 304 can advertise to each over via their out-of-band (OOB) network that they received a packet with its source MAC and checksum.

If Hypervisor A 306 determines that it has hit a threshold of BUM packets missed, then it triggers the link failure mechanism.

In a distributed link topology, the hypervisor will not have a complete failure, but it does now have a lack of redundancy and bandwidth.

In a Link Aggregation Control Protocol (LACP) bond, switches will load balance traffic BUM traffic between links. This means that the local virtual switch will only get one copy of the BUM packet. It can, however, verify that the BUM traffic is being distributed to all of its LACP links.

In a distributed balanced bond, it will see the BUM traffic on both links. Utilizing both BUM traffic and traffic flow of links, processes can get a passive view of the topology. If a process determines that one link has failed, the process can create a redundant connection for both failover capabilities and load balancing.

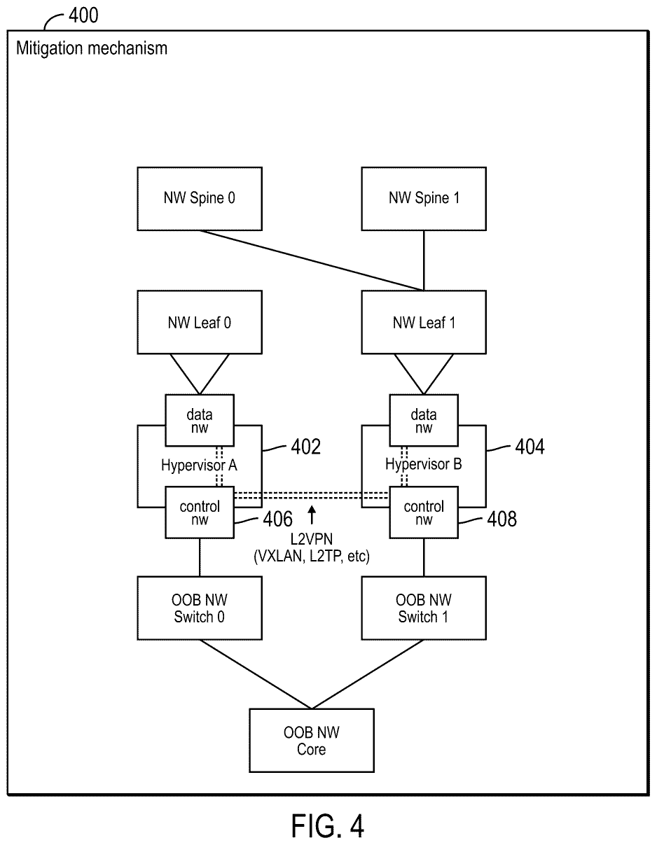

FIG. 4 illustrates a block diagram 400 that shows a mitigation mechanism, in accordance with certain embodiments.

Each hypervisor generates a cost for their links, which includes:
(i) Total link speed; and
(ii) Historical bandwidth saturation percentage over the last 12 hours (12 hours is just an example, and the time period could be something different from 12 hours).

This cost of links is advertised to a multicast group where other hypervisors are subscribing to the group.

The hypervisor with failure determines which device is the best path to choose based on cost and a user defined metric/preference, and creates an L2 (level 2) tunnel to another hypervisor. Both hypervisors 402, 404 use their control network (e.g., 406, 408) as their underlay network.

Hypervisor B 404 in FIG. 4 begins to flow traffic up through data links back to the network. Hypervisor A 402 stops traffic from flowing through its data links, but it does not shut those links down. Hypervisor B 404 will keep links up to see if the failure resolves.

Depending on the failure (total uplink failure or redundancy failure) a host (e.g., a computational device 102) may begin to migrate designated guests to adjacent hypervisors.

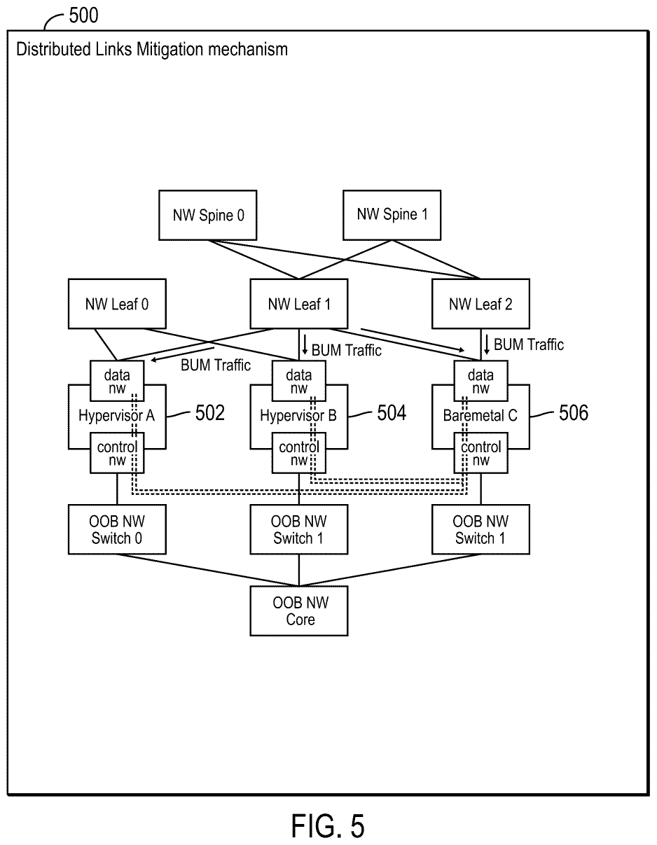

FIG. 5 illustrates a block diagram 500 that shows a distributed links mitigation mechanism, in accordance with certain embodiments. FIG. 5 shows a hypervisor A 502, a hypervisor B 504, and a baremetal C 506, where baremetal C 506 is a physical machine that runs an operating system directly rather than running a hypervisor.

Hypervisors utilize the multicast group to determine what hypervisor is best to fail to. The L2 Tunnel brings the hypervisor back into a redundant link. The hypervisor can load balance packets (based on link speeds). This also allows the hypervisor to remain active in a resource oversubscription scenario.

If the hypervisor is configured as an LACP bond, a new (temporary) bond is created that contains the LACP link and the L2 tunnel. This allows the hypervisor to eliminate the possibility of a layer 2 loop.

In a split topology (system has one link down), the process can use the tunnel to load balance between the hypervisors' outbound links.

The control network can accomplish a self-healing setup by utilizing multicast addresses to auto-discover each other. Once they find other nodes, they can switch to a unicast synchronization to allow connections to other layer 3 domains. Hypervisors can advertise their peers as well, allowing for further auto-discover for hypervisors in other layer 3 domains. Lastly, users can manually create hypervisor peering.

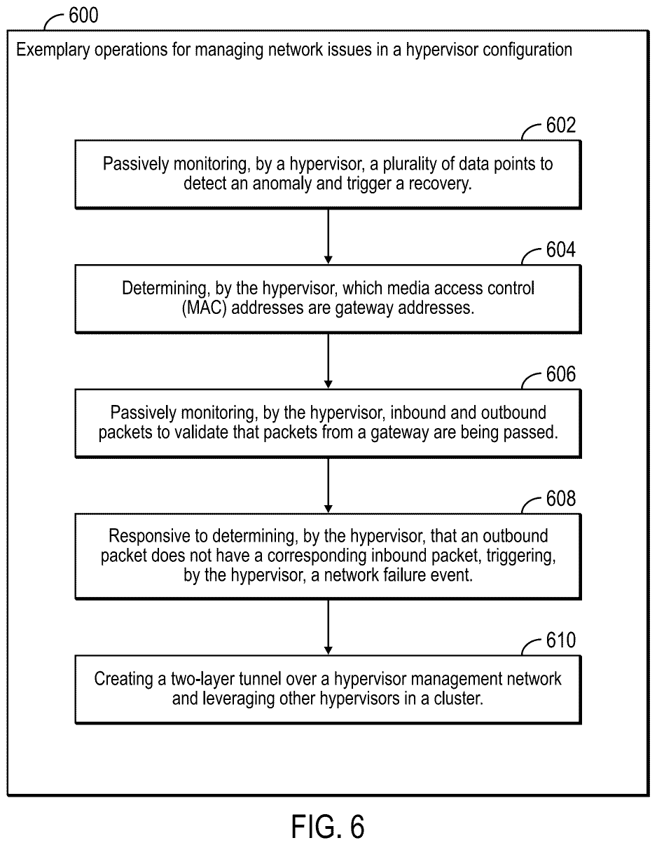

FIG. 6 illustrates a flowchart that shows exemplary operations for managing network issues in a hypervisor configuration, in accordance with certain embodiments.

Control starts at block 602, in which a hypervisor passively monitors a plurality of data points to detect an anomaly and trigger a recovery. The hypervisor then determines (at block 604) which media access control (MAC) addresses are gateway addresses, and passively monitors (at block 606) inbound and outbound packets to validate that packets from a gateway are being passed.

From block 606 control proceeds to block 608, in which responsive to determining, by the hypervisor, that an outbound packet does not have a corresponding inbound packet, the hypervisor triggers a network failure event. Then, a two-layer tunnel is created (at block 610) over a hypervisor management network and other hypervisors in a cluster are leveraged.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

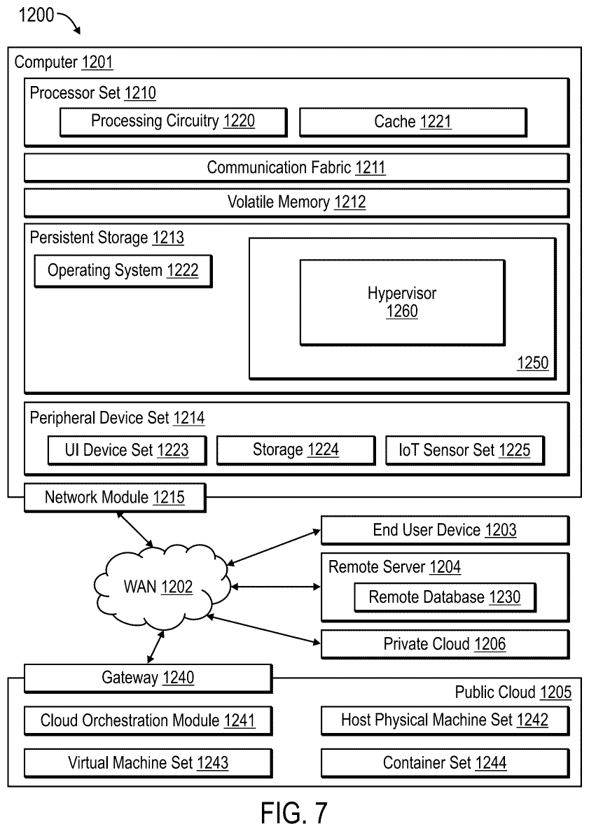

In FIG. 7, a computing environment 1200 contains an example of an environment for the execution of at least some of the computer code (block 1250) involved in performing the operations for a hypervisor 1260 that performs operations shown in FIGS. 1-6.

In addition to block 1250, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1250, as identified above), peripheral device set 1214 (including user interface (UI) device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible computer 1201 may be located in a cloud, even though it is not shown in a cloud in FIG. 6. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1250 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open-source Portable Operating System Interface-type operating systems that employ a kernel. The code included in block 1250 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. I/O T sensor set 1225 is made up of sensors that can be used in Internet of Things applications. For example, one sensor may be a thermometer, and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A method for managing network issues in a hypervisor configuration, the method comprising:
passively monitoring, by a hypervisor, a plurality of data points to detect an anomaly and trigger a recovery;
determining, by the hypervisor, which media access control (MAC) addresses are gateway addresses;
passively monitoring, by the hypervisor, inbound and outbound packets to validate that packets from a gateway are being passed; and
responsive to determining, by the hypervisor, that an outbound packet does not have a corresponding inbound packet, triggering, by the hypervisor, a network failure event.

2. The method of claim 1, the method further comprising:
creating a layer two tunnel over a hypervisor management network and leveraging other hypervisors in a cluster.

3. The method of claim 1, the method further comprising:
passively monitoring, by the hypervisor, broadcast, unknown unicast, and multicast (BUM) packets at a predetermined rate.

4. The method of claim 3, wherein in response to the hypervisor determining that the hypervisor has missed a predetermined threshold number of the BUM packets, the hypervisor triggers a link failure mechanism.

5. The method of claim 1, wherein a plurality of hypervisors synchronize with each other passively captured network traffic that the plurality of hypervisors have received to determine whether a network path has been interrupted, and to determine which hypervisor to fail to.

6. The method of claim 1, the method further comprising:
inspecting, by the hypervisor, Transmission Control Protocol (TCP) packets to validate whether there are corresponding acknowledgments being transmitted to determine occurrence of the network failure event.

7. The method of claim 1, wherein each hypervisor of a plurality of hypervisors generates a cost for links to advertise to other hypervisors of the plurality of hypervisors, wherein a selected hypervisor with a failure creates a tunnel to another hypervisor based on the cost.

8. A system for managing network issues in a hypervisor configuration, the system comprising:
a memory; and
a processor coupled to the memory, wherein the processor performs operations, the operations comprising:
passively monitoring, by a hypervisor, a plurality of data points to detect an anomaly and trigger a recovery;
determining, by the hypervisor, which media access control (MAC) addresses are gateway addresses;
passively monitoring, by the hypervisor, inbound and outbound packets to validate that packets from a gateway are being passed; and
responsive to determining, by the hypervisor, that an outbound packet does not have a corresponding inbound packet, triggering, by the hypervisor, a network failure event.

9. The system of claim 8, the operations further comprising:
creating a layer two tunnel over a hypervisor management network and leveraging other hypervisors in a cluster.

10. The system of claim 8, the operations further comprising:
passively monitoring, by the hypervisor, broadcast, unknown unicast, and multicast (BUM) packets at a predetermined rate.

11. The system of claim 10, wherein in response to the hypervisor determining that the hypervisor has missed a predetermined threshold number of the BUM packets, the hypervisor triggers a link failure mechanism.

12. The system of claim 8, wherein a plurality of hypervisors synchronize with each other passively captured network traffic that the plurality of hypervisors have received to determine whether a network path has been interrupted, and to determine which hypervisor to fail to.

13. The system of claim 8, the operations further comprising:
inspecting, by the hypervisor, Transmission Control Protocol (TCP) packets to validate whether there are corresponding acknowledgments being transmitted to determine occurrence of the network failure event.

14. The system of claim 8, wherein each hypervisor of a plurality of hypervisors generates a cost for links to advertise to other hypervisors of the plurality of hypervisors, wherein a selected hypervisor with a failure creates a tunnel to another hypervisor based on the cost.

15. A computer program product for managing network issues in a hypervisor configuration, the computer program product comprising a computer readable storage medium, wherein code stored in the computer readable storage medium when executed by a processor performs operations, the operations comprising:
passively monitoring, by a hypervisor, a plurality of data points to detect an anomaly and trigger a recovery;
determining, by the hypervisor, which media access control (MAC) addresses are gateway addresses;
passively monitoring, by the hypervisor, inbound and outbound packets to validate that packets from a gateway are being passed; and
responsive to determining, by the hypervisor, that an outbound packet does not have a corresponding inbound packet, triggering, by the hypervisor, a network failure event.

16. The computer program product of claim 15, the operations further comprising:
creating a layer two tunnel over a hypervisor management network and leveraging other hypervisors in a cluster.

17. The computer program product of claim 15, the operations further comprising:
passively monitoring, by the hypervisor, broadcast, unknown unicast, and multicast (BUM) packets at a predetermined rate.

18. The computer program product of claim 17, wherein in response to the hypervisor determining that the hypervisor has missed a predetermined threshold number of the BUM packets, the hypervisor triggers a link failure mechanism.

19. The computer program product of claim 15, wherein a plurality of hypervisors synchronize with each other passively captured network traffic that the plurality of hypervisors have received to determine whether a network path has been interrupted, and to determine which hypervisor to fail to.

20. The computer program product of claim 15, the operations further comprising: inspecting, by the hypervisor, Transmission Control Protocol (TCP) packets to validate whether there are corresponding acknowledgments being transmitted to determine occurrence of the network failure event.
